(19) United States
(12) Patent Application Publication
(10) Pub. No.: US 2007/0170865 A1
(43) Pub. Date: Jul. 26, 2007

(54) Plasma display panel, method for producing the plasma display panel, protective layer of the plasma display panel, and method for forming the proctective layer

(75) Inventor: Min Soo Park, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/656,488

(22) Filed: Jan. 23, 2007

(30) Foreign Application Priority Data
Jan. 23, 2006 (KR) 10-2006-0006830

(51) Int. Cl. H01J 17/49

(52) U.S. Cl. 313/587; 313/582

(57) ABSTRACT

A plasma display panel, a method for producing the plasma display panel, a protective layer of the plasma display panel, and a method for forming the protective layer, are disclosed. A material for the protective layer according to an embodiment includes a nano particle containing single-crystal or polycrystalline magnesium oxide.

This application claims the priority benefit of Korean Patent Application No. 10-2006-0006830, filed on Jan. 23, 2006, which are hereby incorporated by reference as if fully set forth herein.

### BACKGROUND OF THE INVENTION

1. Field of the Invention

The present invention relates to a plasma display panel, and more particularly, to a protective layer of a plasma display panel.

2. Discussion of the Related Art

Generally, plasma display panels include an upper panel, a lower panel, and barrier ribs formed between the upper and lower panels to define respective discharge cells. A major discharge gas such as neon, helium or a mixed gas thereof, and an inert gas containing a small amount of xenon (Xe) are filled within the discharge cells. When a high-frequency voltage is applied to produce a discharge in the discharge cells, vacuum ultraviolet rays are generated from the inert gas to cause phosphors present between the barrier ribs to emit light, and as a result, images are created. Such plasma display panels have attracted more and more attention as the next-generation display devices due to their small thickness and light weight.

FIG. 1 is a perspective view schematically showing the structure of a plasma display panel according to a related art. As shown in FIG. 1, the plasma display panel includes an upper panel 100 and a lower panel 110 integrally joined in parallel to and at a certain distance from the upper panel 100. The upper panel 100 includes an upper glass plate 101 as a display plane on which images are displayed and a plurality of sustain electrode pairs 102, 103, each pair consisting of a transparent electrode ‘a’ and a bus electrode ‘b’, arranged on the upper glass plate 101. The lower panel 110 includes a lower glass plate 111 and a plurality of address electrodes 113 arranged on the lower glass plate 111 so as to cross under the plurality of sustain electrode pairs.

Stripe type (or well type, etc.) barrier ribs 112 for forming a plurality of discharge spaces, i.e. discharge cells, are arranged parallel to each other on the lower panel 110. The plurality of address electrodes 113, which act to perform an address discharge, are arranged in parallel with respect to the barrier ribs 112 to generate vacuum ultraviolet rays. Red (R), green (G) and blue (B) phosphors 114 are applied to the upper sides of the lower panel 110 to emit visible rays upon address discharge, and as a result, images are displayed. A lower dielectric layer 115 is formed between the address electrodes 113 and the phosphors 114 to protect the address electrodes 113.

An upper dielectric layer 104 is formed on the sustain electrode pairs 102, 103, and a protective layer 105 is formed on the upper dielectric layer 104. However, the upper dielectric layer 104, which is included in the upper panel 100, is worn out due to the bombardment of positive (+) ions upon discharge of the plasma display panel. At this time, short circuiting of the electrodes may be caused by metal elements such as sodium (Na) Thus, a magnesium oxide (MgO) thin film as the protective layer 105 can be formed on the upper dielectric layer 104 by coating to protect the upper dielectric layer 104. Generally, magnesium oxide sufficiently withstands the bombardment of positive (+) ions and has a high secondary electron emission coefficient, thus achieving a low firing voltage. Accordingly, the protective layer can be formed to operate the plasma display panel at a low voltage. This low-voltage operation leads to a reduction in the power consumption of the panel, thus contributing to a reduction in the production costs of the panel as well as an improvement in the discharge efficiency and brightness of the panel.

However, the protective layer of the plasma display panel according to the related art has the following problems and limitations.

The protective layer of the plasma display panel according to the related art is formed by a process selected from screen printing, ion plaiting, sputtering and electron beam (e-beam) deposition.

According to the e-beam deposition of the related art, a protective layer is formed by irradiating an electron beam on a target such as magnesium oxide (MgO). However, at this time, magnesium oxide used as the target contains a large amount of hydrogen or water. In addition, impurities are incorporated into the target in the course of the production of MgO particles in the form of a pellet, causing a reduction in the purity of the target. Accordingly, much energy is required to evaporate the MgO particles in the form of a pellet by an electron beam and the evaporation is also retarded, resulting in a deterioration in the quality of the protective layer to be formed.

### SUMMARY OF THE INVENTION

Accordingly, the present invention is directed to a plasma display panel, a method for producing the plasma display panel, a protective layer of the plasma display panel, and a method for forming the protective layer that substantially obviate one or more problems due to limitations and disadvantages of the related art.

An object of the present invention is to provide a protective layer of a plasma display panel containing considerably less impurities and water, and a method for forming the protective layer.

Another object of the present invention is associated with the formation of a protective layer of a plasma display panel with uniform quality for a short period of time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a material for a protective layer of a plasma display panel according to an aspect of the present invention includes a nano particle containing single-crystal or polycrystalline magnesium oxide.

In another aspect of the present invention, there is provided a method for preparing a material for a protective layer of a plasma display panel, the method including introducing a nano particle containing crystalline magnesium oxide into a basket and heating the nano particle placed in the basket.

In another aspect of the present invention, there is provided a method for producing a plasma display panel, the method including placing a nano particle containing single-crystal or polycrystalline magnesium oxide in a vacuum chamber, irradiating the nano particle with an electron beam to evaporate and diffuse the nano particle, and depositing the magnesium oxide contained in the diffused nano particle on an upper dielectric layer to grow the magnesium oxide on the upper dielectric layer.

In yet another aspect of the present invention, there is provided a plasma display panel including a first panel and a second panel facing each other through barrier ribs, wherein the first panel includes a dielectric layer and a protective layer formed on the dielectric layer, and the protective layer is composed of a nano particle containing single-crystal or polycrystalline magnesium oxide particles having a size of approximately 10 nm to 100 nm.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a plasma display panel according to a related art;

FIG. 2 is a perspective view of a material for a protective layer of a plasma display panel according to an embodiment of the present invention;

FIG. 3 is a flow chart illustrating a method for preparing a material for a protective layer of a plasma display panel according to an embodiment of the present invention;

FIG. 4 illustrates a chamber in which a method for producing a plasma display panel is performed according to an embodiment of the present invention; and

FIG. 5 is a cross-sectional view of an upper panel of a plasma display panel according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

A material for a protective layer of a plasma display panel according to the present invention includes a nano particle. The nano particle contains single-crystal or polycrystalline magnesium oxide. The single-crystal magnesium oxide particles are regularly oriented along a specific crystal axis.

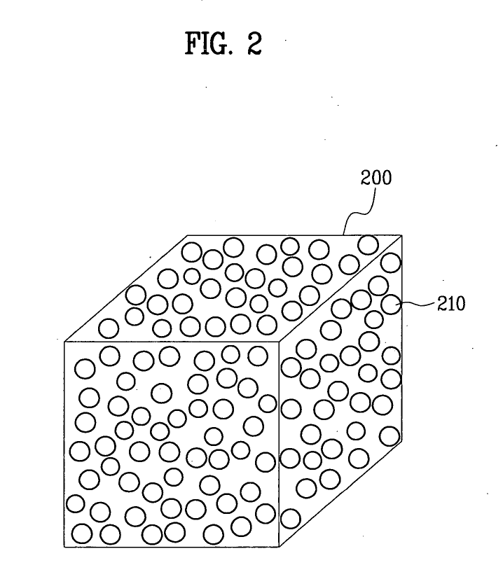

FIG. 2 is a perspective view of a material for a protective layer of a plasma display panel according to an embodiment of the present invention. As shown in FIG. 2, the protective layer according to this embodiment includes nano particles 210, which are preferably in the shape of a porous pellet 200. That is, magnesium oxide particles 210, between which spaces are formed, are present in the form of a pellet 200. Each of the magnesium oxide particles 210 may have a size of 10 nanometers to 100 nanometers (or approximately thereof). Here, if the shape of the crystalline magnesium oxide particles is a sphere, the size of the magnesium oxide particles refers to the diameter of the sphere. Meanwhile, if the shape of the crystalline magnesium oxide particles is a cube, the size of the magnesium oxide particles refers to the length of one side of the cube.

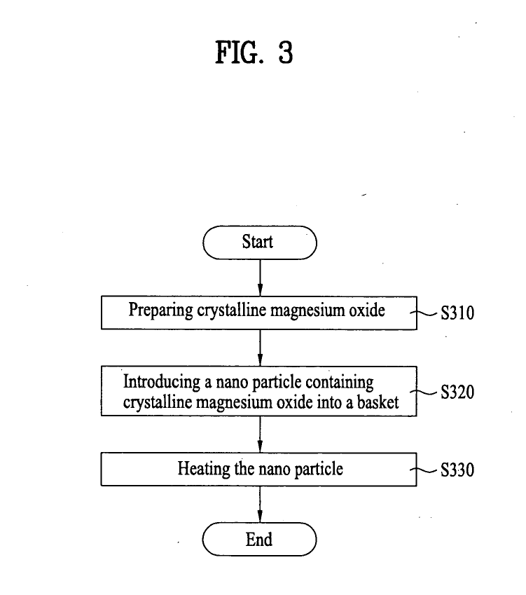

FIG. 3 is a flow chart illustrating a method for preparing a material for a protective layer of a plasma display panel according to an embodiment of the present invention. With reference to FIG. 3, an explanation of the method for preparing the material for the protective layer of the plasma display panel according to an embodiment of the present invention will be provided below.

First, crystalline magnesium oxide is prepared by the following procedure (S310). A doping material is added to crystalline magnesium oxide having a purity of 90% (or about 90%) or higher to form magnesium hydroxide (Mg(OH)₂). That is, the formation of Mg(OH)₂ is to increase the purity of the magnesium oxide and the doping material is added to control the amount of impurities. Since the Mg(OH)₂ contains water in an amount of 50% or about 50%, it is necessary to remove the water from the Mg(OH)₂. The water removal is achieved as follows.

First, a nano particle containing the above crystalline magnesium oxide is introduced into a basket or the like (S320). The crystalline magnesium oxide particle(s) may have a size of 10 nm to 100 nm. A solvent and/or an additive may be mixed with the crystalline magnesium oxide.

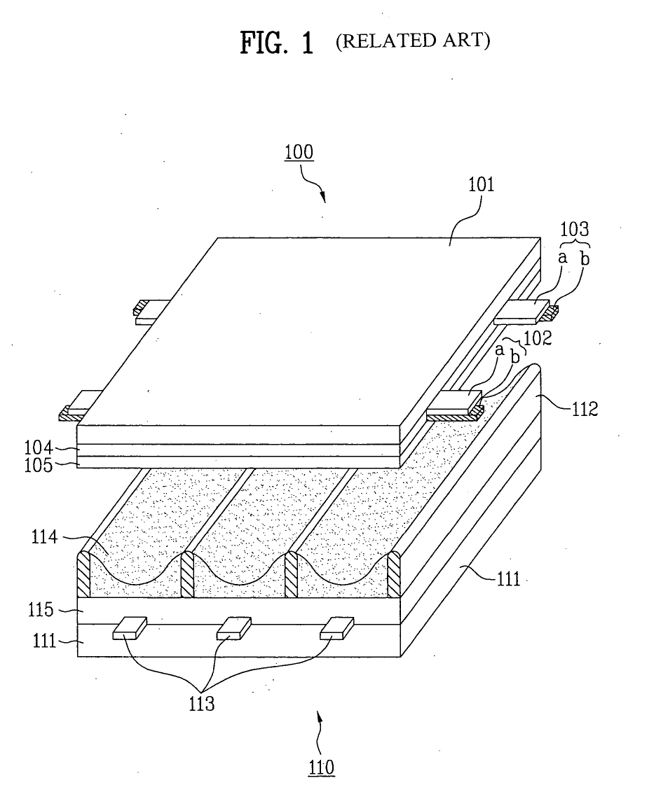

Thereafter, the nano particle is heated to evaporate water and/or impurities adsorbed on the surface of the crystalline magnesium oxide (S330). Spaces are formed in place of the evaporated water and/or impurities. The crystal particles aggregate to form a porous pellet (e.g., pellet 200 shown in FIG. 2) whose surfaces are partially depressed. As a result, the material for a protective layer of a plasma display panel is prepared. Here, the plasma display panel having such protective layer can have the same overall configuration as the plasma display panel shown in FIG. 1 or can have other configurations.

The nano particle may be heated at a temperature of 400 to 900° C. The nano particle may be previously dried at a lower temperature than the heating temperature. The nano particle placed in the basket is heated to remove impurities such as water, from the nano particle, resulting in an increase in the density of the crystal. The shape of the porous pellet can vary depending on the shape of the basket. For instance, the shape and size of the pellet to be formed can be controlled by varying the shape and size of the basket.

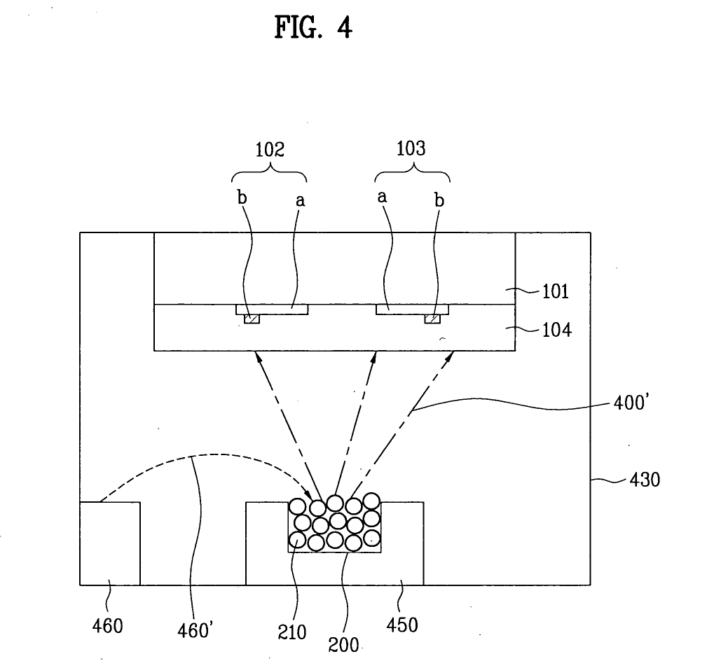

FIG. 4 illustrates a method for producing a plasma display panel according to an embodiment of the present invention. Referring to FIG. 4, an explanation of the method for producing a plasma display panel according to an embodiment of the present invention will be provided below. The method of FIG. 4 preferably utilizes the nano particle 200 of FIGS. 2 and 3, but can utilize other nano particles.

First, a nano particle 200 containing crystalline magnesium oxide is placed in a vacuum chamber 430. The nano particle 200 is in the shape of a porous pellet, only as an example. The nano particle 200 is preferably filled in a crucible 450. Subsequently, the nano particle 200 is irradiated with an electron beam 460′ to evaporate and diffuse the crystalline magnesium oxide contained therein. The nano particle 200 in the shape of the porous pellet has a very large specific surface area. The term ‘specific surface area’ preferably refers to the ratio of the area exposed outside to the total volume of the nano particle. Since the surfaces of the porous pellet are partially depressed, the specific surface area of the nano particle is increased.

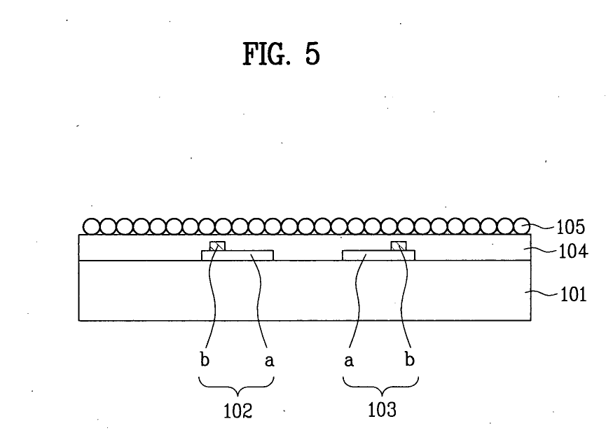

When an electron gun 460 is operated to create electrical and magnetic fields, the electron beam 460′ is emitted from the electron gun to collide with the nano particle 200. That is, ions emitted from the electron gun 460 collide with the material for a protective layer containing the magnesium oxide to evaporate and diffuse the single-crystal or polycrystalline magnesium oxide contained in the nano particle 200. The evaporated magnesium oxide 400′ is deposited on an upper dielectric layer 104 to form a protective layer. For instance, the evaporated magnesium oxide from the pellet 200 is deposited on the dielectric 104 in the upper panel 100 of a plasma display device, so as to form a protective layer 105 as shown in FIGS. 4 and 5. The plasma display panel here can have the same other components as the plasma display panel of FIG. 1 or other related art plasma display device.

When the energy of the electron beam 460′ is concentrated on the surface of the target, high-speed deposition and high purity of the magnesium oxide can be achieved. Although not shown in this figure, the vacuum chamber is provided with a vacuum pump to continuously discharge gases from the chamber.

The protective layer thus formed is composed of the crystalline magnesium oxide particles preferably having a size of 10 nm to 100 nm. Accordingly, the constituent particles of the protective layer have a uniform size. In addition, since the electron beam deposition is conducted in the vacuum chamber, the protective layer substantially contains no impurities. Further, since the nano particle in the shape of a porous pellet also substantially contains no water and impurities, the crystalline MgO from the pellet can be effectively evaporated using a smaller amount of energy than the energy of electron beams used to evaporate crystalline MgO in conventional electron beam deposition processes. Furthermore, since the size of the crystalline MgO is uniform or almost uniform, the high quality of the protective layer is maintained constantly. Other constituent elements of the plasma display panel/device are formed in accordance with respective general processes.

FIG. 5 is a cross-sectional view of an upper panel of a plasma display panel according to an embodiment of the present invention. Referring to FIG. 5, an explanation of the upper panel of the plasma display panel according to an embodiment of the present invention will be provided below.

A three-electrode surface-discharge plasma display panel according to the present invention includes a lower panel, an upper panel and barrier ribs therebetween. The lower panel generally includes a lower substrate, address electrodes formed on portions of the lower substrate, and a lower dielectric layer formed thereon. The barrier ribs are formed on portions of the lower dielectric layer to separate adjacent discharge cells, and phosphors are applied to sides of the barrier ribs and upper portions of the lower dielectric layer. An example of these elements is shown in FIG. 1.

In the upper panel of the plasma display panel according to the present invention, a plurality of sustain electrode pairs 102 and 103 are formed at fixed intervals on an upper substrate 101 so as to cross over the address electrodes of the lower panel. Because of low conductivity of the transparent electrodes (a), the bus electrodes (b) are additionally formed on the transparent electrodes (a) to reduce the resistance of the sustain electrode pairs. An upper dielectric layer 104 is formed to cover the upper substrate 101 and the sustain electrode pairs 102, 103.

A protective layer 105 is formed on the upper dielectric layer 104. The protective layer 105 is formed by the method explained above, e.g., by using the method of FIG. 4 with the pellet 200. Accordingly, the quality of the protective layer 105 is maintained to be high and constant, because the crystal particles of the protective layer 105 preferably have a size of 10 nm to 100 nm and the protective 105 layer is formed without substantial impurities within a vacuum chamber.

Once the upper and lower panels are formed as discussed above, the upper panel and the lower panel facing the upper panel are integrally joined to form discharge cells therebetween of the plasma display panel. A mixed inert gas such as He+Xe, Ne+Xe or He+Ne+Xe, is introduced as a discharge gas into the discharge cells.

Accordingly, the present invention provides an effective protective layer of a plasma display panel and an effective method for forming the protective layer, which address the limitations and disadvantages associated with the protective layer and the method of forming the protective layer according to the related art.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A material for a protective layer of a plasma display panel, comprising:
a nano particle containing single-crystal magnesium oxide.

2. The material according to claim 1, wherein the nano particle is in the shape of a porous pellet.

3. The material according to claim 1, wherein particles of the single-crystal magnesium oxide have a size of approximately 10 nanometers to 100 nanometers.

4. A material for a protective layer of a plasma display panel, comprising:
a nano particle containing polycrystalline magnesium oxide.

5. The material according to claim 4, wherein the nano particle is in the shape of a porous pellet.

6. The material according to claim 4, wherein particles of the polycrystalline magnesium oxide have a size of approximately 10 nanometers to 100 nanometers.

7. A method for preparing a material for a protective layer of a plasma display panel, the method comprising:
introducing a nano particle containing crystalline magnesium oxide into a basket; and
heating the nano particle placed in the basket.

8. The method according to claim 7, wherein the crystalline magnesium oxide is single-crystal magnesium oxide or polycrystalline magnesium oxide.

9. The method according to claim 7, wherein particles of the crystalline magnesium oxide have a size of approximately 10 nanometers to 100 nanometers.

10. The method according to claim 7, wherein the nano particle is heated at a temperature of approximately 400° C. to 900° C.

11. The method according to claim 7, wherein the heating step removes impurities from the nano particle and forms a porous pellet depending on the shape of the basket.

12. The method according to claim 7, wherein the crystalline magnesium oxide of the nano particle introduced into the basket has a purity of approximately 90%.

13. The method according to claim 7, wherein the crystalline magnesium oxide of the nano particle introduced into the basket includes magnesium hydroxide (Mg(OH)₂).

14. The method according to claim 7, wherein the nano particle introduced into the basket further includes a solvent and/or an additive mixed to the crystalline magnesium oxide.

15. A method for forming a protective layer of a plasma display panel, the method comprising:
placing a nano particle containing single-crystal or polycrystalline magnesium oxide in a vacuum chamber;
irradiating the nano particle with an electron beam to evaporate and diffuse the nano particle; and
depositing the magnesium oxide contained in the diffused nano particle on an upper dielectric layer to grow the magnesium oxide on the upper dielectric layer.

16. The method according to claim 15, wherein the nano particle placed in the vacuum chamber is in the shape of a porous pellet.

17. The method according to claim 15, wherein particles of the single-crystal or polycrystalline magnesium oxide have a size of approximately 10 nanometers to 100 nanometers.

18. The method according to claim 15, wherein the single-crystal or polycrystalline magnesium oxide of the nano particle has a purity of approximately 90%.

19. A plasma display panel comprising:
a first panel and a second panel facing each other with barrier ribs therebetween,
wherein the first panel includes a dielectric layer and a protective layer formed on the dielectric layer, and the protective layer is composed of a nano particle containing single-crystal or polycrystalline magnesium oxide particles having a size of approximately 10 nm to 100 nm.

20. The plasma display panel according to claim 19, wherein the first panel further includes a plurality of sustain electrodes formed under the dielectric layer.
